(19) United States
(12) Patent Application Publication
(10) Pub. No.: US 2024/0382805 A1
(43) Pub. Date: Nov. 21, 2024

(54) METHOD AND DEVICE FOR COUNTING PUSH-UPS

(71) Applicant: Dongguan Chuan OptoElectronics Limited, Dongguan (CN)

(72) Inventor: YIQUAN LIU, Dongguan (CN)

(21) Appl. No.: 18/228,810

(22) Filed: Aug. 1, 2023

(30) Foreign Application Priority Data
May 18, 2023 (CN) 202310566539.2

(51) Int. Cl. A63B 24/00; A63B 23/12; A63B 71/06

(52) U.S. Cl. CPC A63B 24/0062; A63B 23/1236; A63B 71/0622; A63B 2024/0068; A63B 2071/0625; A63B 2220/17; A63B 2220/20; A63B 2220/805

(57) ABSTRACT

A method and device for counting push-ups, comprising: detecting an user's ground lift data in real time; according to the ground lift data, if a user continuously goes down from a preset highest point and passes a preset lowest point, and then continuously goes up and passes the preset highest point, judging as an effective action, then counting once; otherwise, judging as an invalid action. In this way, a posture dynamic process capture is realized. Only when the user completes a set of complete and standard actions from the highest point down to the lowest point, and then back to the highest point from the lowest point, so that only standard actions are counted, thereby preventing misjudgment caused by non-standard actions.

### CROSS-REFERENCE TO RELATED APPLICATIONS

This is a U. S. patent application which claims the priority and benefit of Chinese Patent Application Number 202310566539. 2, filed on May 18, 2023, the disclosure of which is incorporated herein by reference in its entirety.

### TECHNICAL FIELD

The present application relates to the technical field of motion counting, in particular to a method and device for counting push-ups.

### BACKGROUND

With the development of the economy, people pay more and more attention to their own health. Push-ups are one of the most commonly used fitness methods, and the count of push-ups is the most important index in push-up training.

The existing intelligent push-up counting is usually to set a sensor at a certain fixed position, and to count by detecting the up and down repetitive motion of the human body. For example, a patent application with publication number CN104922888A discloses a push-up counting method based on an intelligent mobile terminal, comprising: A, the intelligent mobile terminal receives an operation command from the user to enable the push-up counting function, and selects the counting mode; B. according to the selected counting mode, the intelligent mobile terminal placed at a designated position obtains the user to do push-ups and repeatedly moves up and down through sensor induction, wherein each cycle of up and down motion is counted once; C. when the counting is completed, the counting result is prompted. This patent application utilizes smart mobile terminals as sensors. The more common intelligent push-up counting device on the market is to set the sensor at a certain fixed height of the device.

However, the above-mentioned technology counts only by simply detecting the repetitive movement up and down, and cannot judge whether the action is effective.

### SUMMARY

In view of the above-mentioned deficiencies in the prior art, the technical problem to be solved by the present application is: to provide a method and device for counting push-ups, which can judge whether the user's push-up movements are standard and valid, and avoid misjudgment.

In order to solve the above-mentioned technical problems, the technical solution that the present application adopts is:

A method for counting push-ups, comprises:
detecting an user's ground lift data in real time;
according to the ground lift data, if a user continuously goes down from a preset highest point and passes a preset lowest point, and then continuously goes up and passes the preset highest point, judging as an effective action, then counting once; otherwise, judging as an invalid action.

Another technical solution that the present application adopts is:

A device for counting push-ups, comprises a sensor, a memory, a processor and a computer program stored on the memory and operable on the processor, the sensor is configured for detecting an user's ground lift data in real time, wherein the following steps are implemented when the processor executes the computer program:
according to the ground lift data, if a user continuously goes down from a preset highest point and passes a preset lowest point, and then continuously goes up and passes the preset highest point, judging as an effective action, then counting once; otherwise, judging as an invalid action.

The beneficial effect of this application is: a posture dynamic process capture is realized. Only when the user completes a set of complete and standard actions from the highest point down to the lowest point, and then back to the highest point from the lowest point, so that only standard actions are counted, thereby preventing misjudgment caused by non-standard actions.

### BRIEF DESCRIPTION OF DRAWINGS

FIG. 1 shows a schematic flowchart of a method for counting push-ups according to an embodiment of the present application;

FIG. 2 is a schematic structural diagram of a device for counting push-ups according to an embodiment of the present application.

Reference signs: 1. Device for counting push-ups; 2. Sensor; 3. Memory; 4. Processor.

### DETAILED DESCRIPTION

In order to better understand the technical content, the achieved purpose and the effect of the present application, the present application will be described in detail below in conjunction with specific embodiments and accompanying drawings. It should be noted that, in the case of no conflict, the embodiments of the present application and the features in the embodiments can be combined with each other. A lot of specific details are set forth in the following description to facilitate a full understanding of the present application, and the described implementations are only a part of the implementations of the present application, but not all of the implementations. Based on the implementation manners in the present application, all other implementation manners obtained by persons of ordinary skill in the art without making creative efforts belong to the protection scope of the present application.

It should be noted that the ground lift data mentioned in the present application is the data of the distance to the platform supported by the human body when the action is performed.

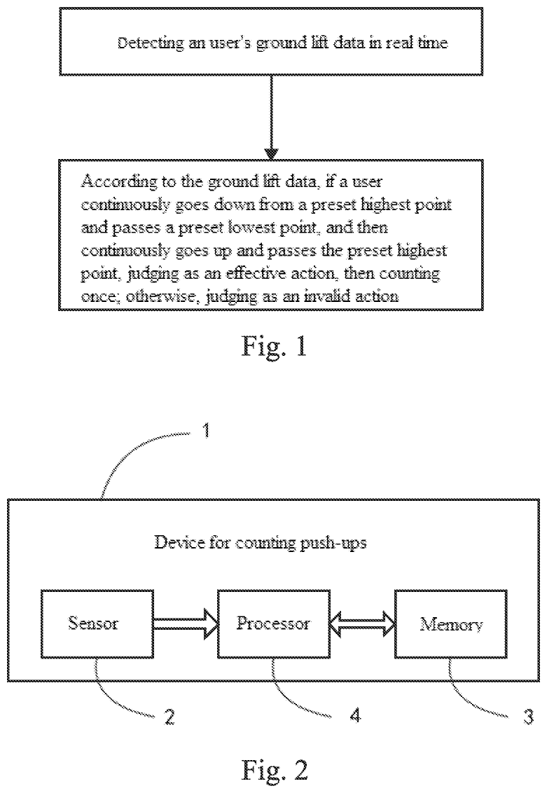

Please refer to FIG. 1, the present application provides a method for counting push-ups, comprising:
detecting an user's ground lift data in real time;
according to the ground lift data, if a user continuously goes down from a preset highest point and passes a preset lowest point, and then continuously goes up and passes the preset highest point, judging as an effective action, then counting once; otherwise, judging as an invalid action.

The beneficial effect of above-mentioned method for counting push-ups is: a posture dynamic process capture is realized. Only when the user completes a set of complete and standard actions from the highest point down to the lowest point, and then back to the highest point from the lowest point, so that only standard actions are counted, thereby preventing misjudgment caused by non-standard actions.

Further, before the detection of the user's ground lift data in real time, the method further comprises: presetting marks, wherein the marks comprise a highest point mark and a lowest point mark;
if the user continuously goes down from the preset highest point and passes the preset lowest point, and then continuously goes up and passes the preset highest point, judging as the effective action, then counting once; otherwise, judging as the invalid action, specifically comprising:
   if it is detected that the user's ground lift data has the highest point mark and then the data is a continuously decreasing data change mark, judging whether the ground lift data continues to appear the lowest point mark; otherwise, judging as an invalid action;
   if the lowest point mark appears and then the data is a continuously increasing data change mark and then returns to the highest point mark, then counting once; otherwise, judging as the invalid action.

Further, the marks comprise: a downward process mark and an upward process mark, wherein according to the downward process mark, judging whether the data is a continuously decreasing data change mark, and according to the upward process mark, judging whether the data is a continuously increasing data change mark. Specifically, if the data that is continuously larger than the downward process mark and the data that is continuously smaller than the downward process mark appear successively according to the time, it is judged as a continuously decreasing data change mark; if the data that is continuously smaller than the upward process mark and the data that is continuously greater than the upward process mark appear successively according to the time, then it is judged as a continuously increasing data change mark.

It can be known from the above description that the present application captures the dynamic process of motion postures by way of marking, so as to determine whether the action is valid. Specifically, it can be realized by setting four mark points, namely, the highest point mark, the downward process mark, the lowest point mark, and the upward process mark to increase flexibility.

Further, the highest point mark is 30-45 cm from the ground, and the lowest point mark is 0-20 cm from the ground.

As can be seen from the above description, set 20-30 cm as the measurement distance to simulate the progress of the action. Less than 20 cm is regarded as the ground distance, and 30-45 cm is regarded as the starting and resting distance. The aforementioned distance range setting can meet the usage requirements of different users, and improves the adaptability.

Further, a voice broadcast is performed during a counting process, and when detecting that the user continuously goes down from the highest point, then stopping the broadcast.

From the above description, it can be seen that by adding voice announcements, such as voice reporting, sound effects, etc., the user experience is improved. However, after the action is matched with the voice, too frequent voice switching may occur, which may easily lead to unsmooth voice. By detecting that the user is continuously going down from the highest point, that is, after the next action starts, the voice broadcast is forcibly interrupted, so that the action has no voice back shake.

Further, the ground lift data is a ground lift data from a middle position of the user's chest to the ground.

It can be seen from the above description that the change of the middle position of the chest is one of the most important indicators of the dynamic change of the push-up action, and the change of the position is relatively easy to realize in measurement, and the measurement accuracy is improved.

Further, the user's ground lift data is detected by using TOF laser sensing technology.

It can be seen from the above description that TOF laser sensing technology has higher stability and light resistance, which effectively improves the accuracy of counting.

Please refer to FIG. 2, the present application provides a device for counting push-ups 1 which is corresponding to above-mentioned method for counting push-ups, comprising a sensor 2, a memory 3, a processor 4 and a computer program stored on the memory 3 and operable on the processor 4. The sensor 2 is configured for detecting an user's ground lift data in real time, wherein the following steps are implemented when the processor 4 executes the computer program:
according to the ground lift data, if a user continuously goes down from a preset highest point and passes a preset lowest point, and then continuously goes up and passes the preset highest point, judging as an effective action, then counting once; otherwise, judging as an invalid action.

The beneficial effect of above-mentioned device for counting push-ups is: a posture dynamic process capture is realized. Only when the user completes a set of complete and standard actions from the highest point down to the lowest point, and then back to the highest point from the lowest point, so that only standard actions are counted, thereby preventing misjudgment caused by non-standard actions.

The above-mentioned sensor 2 is a distance sensor, preferably a TOF laser sensor.

Further, before the detection, it further comprises: presetting marks, wherein the marks comprise a highest point mark and a lowest point mark;
if the user continuously goes down from the preset highest point and passes the preset lowest point, and then continuously goes up and passes the preset highest point, judging as the effective action, then counting once; otherwise, judging as the invalid action, specifically comprising:
   if it is detected that the user's ground lift data has the highest point mark and then the data is a continuously decreasing data change mark, judging whether the ground lift data continues to appear the lowest point mark; otherwise, judging as an invalid action;
   if the lowest point mark appears and then the data is a continuously increasing data change mark and then returns to the highest point mark, then counting once; otherwise, judging as the invalid action.

Further, the marks comprise: a downward process mark and an upward process mark, wherein according to the downward process mark, judging whether the data is a continuously decreasing data change mark, and according to the upward process mark, judging whether the data is a continuously increasing data change mark. Specifically, if the data that is continuously larger than the downward process mark and the data that is continuously smaller than the downward process mark appear successively according to the time, it is judged as a continuously decreasing data change mark; if the data that is continuously smaller than the upward process mark and the data that is continuously greater than the upward process mark appear successively according to the time, then it is judged as a continuously increasing data change mark.

It can be known from the above description that the present application captures the dynamic process of motion postures by way of marking, so as to determine whether the action is valid. Specifically, it can be realized by setting four mark points, namely, the highest point mark, the downward process mark, the lowest point mark, and the upward process mark to increase flexibility.

Further, the highest point mark is 30-45 cm from the ground, and the lowest point mark is 0-20 cm from the ground.

As can be seen from the above description, set 20-30 cm as the measurement distance to simulate the progress of the action. Less than 20 cm is regarded as the ground distance, and 30-45 cm is regarded as the starting and resting distance. The aforementioned distance range setting can meet the usage requirements of different users, and improves the adaptability.

Please refer to FIG. 1, the first embodiment of the present application is:

A method for counting push-ups, which uses TOF laser sensing technology to detect the user's ground lift data. The working mode of laser sensing can be set as: 0-20 cm from the ground is the accurate measurement distance, 20-30 cm is the buffer distance; the maximum measurement distance of the hardware is 200 cm, the sampling rate is 60 mm/time.

The specific process includes:

Presetting marks, wherein the marks comprise a highest point mark a downward process mark, a lowest point mark and an upward process mark. The highest point mark is 30-45 cm from the ground, and the lowest point mark is 0-20 cm from the ground. The downward process mark is located between the highest point down to the lowest point, and the upward process mark is located between the lowest point up to the highest point.

Detecting the ground lift data between the middle position of the user's chest and the ground in real time.

According to the ground lift data, if a user continuously goes down from a preset highest point and passes a preset lowest point, and then continuously goes up and passes the preset highest point, judging as an effective action, then counting once; otherwise, judging as an invalid action and stopping the counting. Specifically, after detecting the highest point mark in the user's ground lift data, according to the time sequence, if the data continues to decrease, and the range that does not enter the lowest point mark continues to increase, then the subsequent upward process will not be judged, it will be judged as an invalid action, and the counting will end. If the data continues to decrease, and the data that is continuously larger than the downward process mark and the data that is continuously smaller than the downward process mark appear successively according to the time, and does not enter the range of the lowest point mark, then the data is judged to be a continuously decreasing data change mark. After judging that the data is continuously smaller than the data change mark, if the data enters the range of the lowest point mark, and the data that is continuously smaller than the upward process mark and the data that is continuously greater than the upward process mark appear successively according to the time, then the data is judged to be a continuously increasing data change mark. After judging that the data is a continuously increasing data change mark, if the data enters the range of the highest point mark, it will be judged as a valid action and counted once. Otherwise, it is judged as an invalid action, and the counting ends.

Due to the marking posture, there may be a problem that the user stops halfway through the action, and needs to continue to complete the last action next time. In this embodiment, as long as it is judged as an invalid action, the counting ends, and the user returns to the leaving state, and starts counting again by performing a new action next time.

In a preferred setting, voice broadcast is also performed during the counting process, such as voice reporting, sound effects, etc. When it is detected that the user has continuously descended from the highest point, the broadcast will stop. You can also set a timer to adjust the training intensity and rest time, so as to achieve the purpose of strengthening training.

Please refer to FIG. 2, the second embodiment of the present application is:

A device for counting push-ups 1, which is corresponding to above-mentioned method for counting push-ups, comprises a sensor 2, a memory 3, a processor 4 and a computer program stored on the memory 3 and operable on the processor 4. The sensor 2 is configured for detecting an user's ground lift data in real time, and the processor 4 acquires the ground lift data detected by the sensor 2 in real time. The sensor 2 is a TOF laser sensor. Specially, the working mode of the sensor 2 can be set as: 0-20 cm from the ground is the accurate measurement distance, 20-30 cm is the buffer distance; the maximum measurement distance of the hardware is 200 cm, the sampling rate is 60 mm/time.

The following steps are implemented when the processor 4 executes the computer program:

Presetting marks, wherein the marks comprise a highest point mark a downward process mark, a lowest point mark and an upward process mark. The highest point mark is 30-45 cm from the ground, and the lowest point mark is 0-20 cm from the ground. The downward process mark is located between the highest point down to the lowest point, and the upward process mark is located between the lowest point up to the highest point.

Detecting the ground lift data between the middle position of the user's chest and the ground in real time.

If it is detected that the highest point mark appears in the ground lift data and then the data is a continuously decreasing data change mark, it is judged whether the lowest point mark continues to appear in the ground lift data, otherwise, it is judged as an invalid action, and the counting ends. If the lowest point mark appears and the data is a continuously increasing data change mark and then returns to the highest point mark, it is judged as a valid action and counted once, otherwise it is judged as an invalid action and the counting ends.

According to the time sequence, if the data that is continuously larger than the downward process mark and the data that is continuously smaller than the downward process mark appear, it is judged as a continuously decreasing data change mark. According to the time sequence, if the data that is continuously smaller than the upward process mark and the data that is continuously greater than the upward process mark appear, it is judged as a continuously increasing data change mark.

In a preferred setting, voice broadcast is also performed during the counting process, such as voice reporting, sound effects, etc. When it is detected that the user has continuously descended from the highest point, the broadcast will stop. You can also set a timer to adjust the training intensity and rest time, so as to achieve the purpose of strengthening training.

To sum up, the method and device for counting push-ups according to the present application use TOF laser sensing technology, and the data is stable and accurate. Capture the dynamic process of gestures by setting markers, adapt to the actions of different people, and only count valid actions to avoid misjudgment. Use voice to improve user experience, and can forcibly interrupt the voice to prevent the voice back shake.

The above are only examples of the present application, and are not intended to limit the patent scope of the present application. Therefore, any modifications, equivalent changes and amendments made to the above embodiments according to the technical essence of the present application without departing from the content of the technical solutions of the present application still fall within the scope of the technical solution of the present application.

What is claimed is:

1. A method for counting push-ups, comprising:
detecting an user's ground lift data in real time;
according to the ground lift data, if a user continuously goes down from a preset highest point and passes a preset lowest point, and then continuously goes up and passes the preset highest point, judging as an effective action, then counting once; otherwise, judging as an invalid action.

2. The method for counting push-ups according to claim 1, wherein before the detection of the user's ground lift data in real time, the method further comprising: presetting marks, wherein the marks comprise a highest point mark and a lowest point mark;
if the user continuously goes down from the preset highest point and passes the preset lowest point, and then continuously goes up and passes the preset highest point, judging as the effective action, then counting once; otherwise, judging as the invalid action, specifically comprising:
if it is detected that the user's ground lift data has the highest point mark and then the data is a continuously decreasing data change mark, judging whether the ground lift data continues to appear the lowest point mark; otherwise, judging as an invalid action;
if the lowest point mark appears and then the data is a continuously increasing data change mark and then returns to the highest point mark, then counting once; otherwise, judging as the invalid action.

3. The method for counting push-ups according to claim 2, wherein further comprising: a downward process mark and an upward process mark, wherein according to the downward process mark, judging whether the data is a continuously decreasing data change mark, and according to the upward process mark, judging whether the data is a continuously increasing data change mark.

4. The method for counting push-ups according to claim 2, wherein the highest point mark is 30-45 cm from the ground, and the lowest point mark is 0-20 cm from the ground.

5. The method for counting push-ups according to claim 1, wherein a voice broadcast is performed during a counting process, and when detecting that the user continuously goes down from the highest point, then stopping the broadcast.

6. The method for counting push-ups according to claim 1, wherein the ground lift data is a ground lift data from a middle position of the user's chest to the ground.

7. The method for counting push-ups according to claim 1, wherein the user's ground lift data is detected by using TOF laser sensing technology.

8. A device for counting push-ups, comprising a sensor, a memory, a processor and a computer program stored on the memory and operable on the processor, the sensor is configured for detecting an user's ground lift data in real time, wherein the following steps are implemented when the processor executes the computer program:
according to the ground lift data, if a user continuously goes down from a preset highest point and passes a preset lowest point, and then continuously goes up and passes the preset highest point, judging as an effective action, then counting once; otherwise, judging as an invalid action.

9. The device for counting push-ups according to claim 8, wherein before the detection, further comprising: presetting marks, wherein the marks comprise a highest point mark and a lowest point mark;
if the user continuously goes down from the preset highest point and passes the preset lowest point, and then continuously goes up and passes the preset highest point, judging as the effective action, then counting once; otherwise, judging as the invalid action, specifically comprising:
wherein if it is detected that the user's ground lift data has the highest point mark and then the data is a continuously decreasing data change mark, judging whether the ground lift data continues to appear the lowest point mark; otherwise, judging as an invalid action;
wherein if the lowest point mark appears and then the data is a continuously increasing data change mark and then returns to the highest point mark, then counting once; otherwise, judging as the invalid action.

10. The device for counting push-ups according to claim 9, wherein the highest point mark is 30-45 cm from the ground, and the lowest point mark is 0-20 cm from the ground.
